(19) United States
(12) Patent Application Publication
(10) Pub. No.: US 2009/0168771 A1
(43) Pub. Date: Jul. 2, 2009

(54) TELEPHONE SYSTEM, AND TERMINAL DEVICE THEREOF, AND CONFIRMATION METHOD FOR THE DEVICE

(75) Inventor: Shuji Yamazaki, Koganei-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/252,740

(22) Filed: Oct. 16, 2008

(30) Foreign Application Priority Data
Dec. 26, 2007 (JP) 2007-335285

(51) Int. Cl. H04L 12/28; H04L 12/66

(52) U.S. Cl. 370/389; 370/352

(57) ABSTRACT

According to one embodiment, if the message makes a round in accordance with the order put to the IPTs in advance, the main unit recognizes that all the IPTs are connected to the LAN. If the end message comes back to the main unit for the start message transmitted from the main unit, all the IPTs are present on the LAN. The IPTs mutually perform the keep-alive processing among terminals in turn. In the process, if timeout occurs, the IPT which has detected the occurrence notifies the absence of the next IPT to the main unit, and change the order of the keep-alive processing.

### CROSS-REFERENCE TO RELATED APPLICATIONS

This application is based upon and claims the benefit of priority from Japanese Patent Application No. 2007-335285, filed Dec. 26, 2007, the entire contents of which are incorporated herein by reference.

### BACKGROUND

1. Field

One embodiment of the invention relates to a telephone system in which telephone terminals and software-implemented telephones, etc., transmit and receive packets to achieve voice communication, and terminal devices of this kind of system, and method for confirming presence of the terminal devices.

2. Description of the Related Art

It is important for operate an operation of the telephone system to confirm the presence of individual telephone terminals. That is, it is necessary to confirm whether or not the telephone terminals have already been connected to a telephone network or already removed from the telephone network for each telephone terminal. More specifically, when a telephone set has been removed from the telephone network, it is preferable to immediately detect the fact to close a line. In the conventional telephone system including an exchange as a main unit, since a defect can be detected quickly (within about 2-3 seconds) due to removal of a telephone terminal from a modular jack, it is relatively easy to confirm presence or non-presence of the telephone terminals.

Meanwhile, a telephone system so-called a Voice over Internet Protocol (VoIP) which achieves voice communication using an Internet Protocol (IP) network has become widely used. In the VoIP system, the voice communication is achieved through packet transmission on an IP network. This kind of system, telephone terminals are connected to a local area network (LAN). Therefore, if a LAN cable is disconnected from the telephone terminal, a main unit cannot detect that the telephone terminal becomes absent until a signal is communicated between the main unit and the telephone terminal.

That is, in the IP telephone system, it takes a relatively long time from the occurrence of a presence or non-presence event of the telephone terminal until the fact is detected by the main unit. To shorten this time, it is appropriate to shorten start intervals of keep-alive processing. The keep-alive processing is processing to be performed so that the main unit keeps the telephone terminals in their operation states. However, since keep-alive signals increase in proportion to the number of telephone terminals, the larger the number of connections of IP telephone terminals becomes, the heavier processing burden on the main unit side becomes, and the heavier communication burden on communication due to increase in traffic becomes. Tremendous increases pose occupancy of a communication band by the keep-alive signals and a problem such that the occupancy be an obstacle for primary voice communication is produced. That is, in the IP telephone system, the increase in number of telephone terminals poses a defect that removal of telephone terminals from the network cannot be detected quickly.

Related technology is disclosed in the following references. A technology disclosed in Jpn. Pat. Appln. KOKAI Publication No. 2006-166018 does not carry out keep-alive processing among a plurality of telephone terminals simultaneously, and keep-alive requests are made while staggering time from the main unit for each terminal. Even using this technology, the increase in the number of terminals poses the foregoing defect.

A technology, which can monitor defect information of all devices on a network by browsing defect management information inter-terminal in turn and by making a circuit of detect management information, is disclosed in Jpn. Pat. Appln. KOKAI Publication No. 2004-187196. This technology needs to prepare special information that is defect management information. Since a data size of the defect management information may become cumulatively large in accordance with the number of terminals, this technology is not so agreeable. A technology disclosed in Jpn. Pat. Appln. KOKAI Publication No. 2000-224210, failures of the terminals are individually detected in a clockwise direction and a counter-clockwise direction to a network topology then it is required to transmit and receive data interactively.

As mentioned above, the IP telephone system cannot easily perform a process to confirm the presence or non-presence of the terminals. In recent years, several hundreds or several thousands of terminals may be connected in one telephone system. The larger the number of connected terminals is, the longer the time to be required from the start to the end of the process is, and the heavier the burden on resources of the main unit and the wider the communication band becomes. In an extreme case, since a defect occurs in voice communication, some countermeasures are required. Such a defect occurs similarly not only on the IP telephone system, but also in a system in which the main unit and terminals are connected via a LAN.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a system view illustrating an embodiment of a telephone system;

FIG. 2 is a functional block diagram illustrating an embodiment of a main unit 10 of FIG. 1;

FIG. 3 is a schematic view illustrating an example of a setting table 14a;

FIG. 4 is a functional block diagram illustrating an embodiment of IP terminals (IPTs) a1-an, b1-bm of FIG. 1;

FIG. 5 is a schematic view illustrating a message flow in an embodiment of a method for confirming presence of terminals;

FIG. 6 is a sequence view illustrating a processing procedure in the embodiment;

FIG. 7 is a schematic view illustrating a message flow in a case of detection of non-presence of terminals in the embodiment;

FIG. 8 is a schematic view illustrating a message flow when the main unit 10 has detected the non-presence of the terminal;

FIG. 9 is a sequence view illustrating a processing procedure in the case of non-presence of terminals in the embodiment;

FIG. 10 is a flowchart illustrating a processing procedure in the main unit 10 in keep-alive processing;

FIG. 11 is a flowchart illustrating a processing procedure at an IP terminal in the keep-alive processing;

FIG. 12 is another flowchart illustrating a processing procedure at the IP terminal in the keep-alive processing;

FIG. 13 is further flowchart illustrating a processing procedure at the IP terminal in the keep-alive processing; and

FIG. 14 is further flowchart illustrating a processing procedure at the IP terminal in the keep-alive processing.

### DETAILED DESCRIPTION

Various embodiments according to the invention will be described hereinafter with reference to the accompanying drawings. In general, according to one embodiment of the invention, there is provided a telephone system, including a plurality of terminal devices configured to perform telephone communication via a packet communication network; and a main unit configured to accommodate the plurality of terminal devices via the packet communication network, wherein a first terminal device and order which starts from the first terminal device to come back to the first terminal device while making a round the plurality of terminal devices are specified to the plurality of terminal devices in advance. The main unit includes a transmission module which transmits a start message to the first terminal device via the packet communication network; and a confirmation processing module which confirms that the respective connections of the plurality of terminal devices to the packet communication network are normal when an end message to the transmitted start message is received from the first terminal device via the packet communication network. The terminal device includes a message processing module which mutually transmits and receives messages to and from other terminal devices via the packet communication network. The message processing module transmits a confirmation message to a terminal device next to its own terminal in accordance with the order when the start message is received, replies a response message to a terminal device of a transmission origin of the confirmation message when the confirmation message is received, transmits a notification message to a terminal device of a transmission origin of the response message when the response message is received, and transmits the confirmation message to the terminal device next to its own terminal in accordance with the order if its own terminal is not the first terminal device, and transmits the end message to the main unit if its own terminal is the first terminal device when the notification message is received.

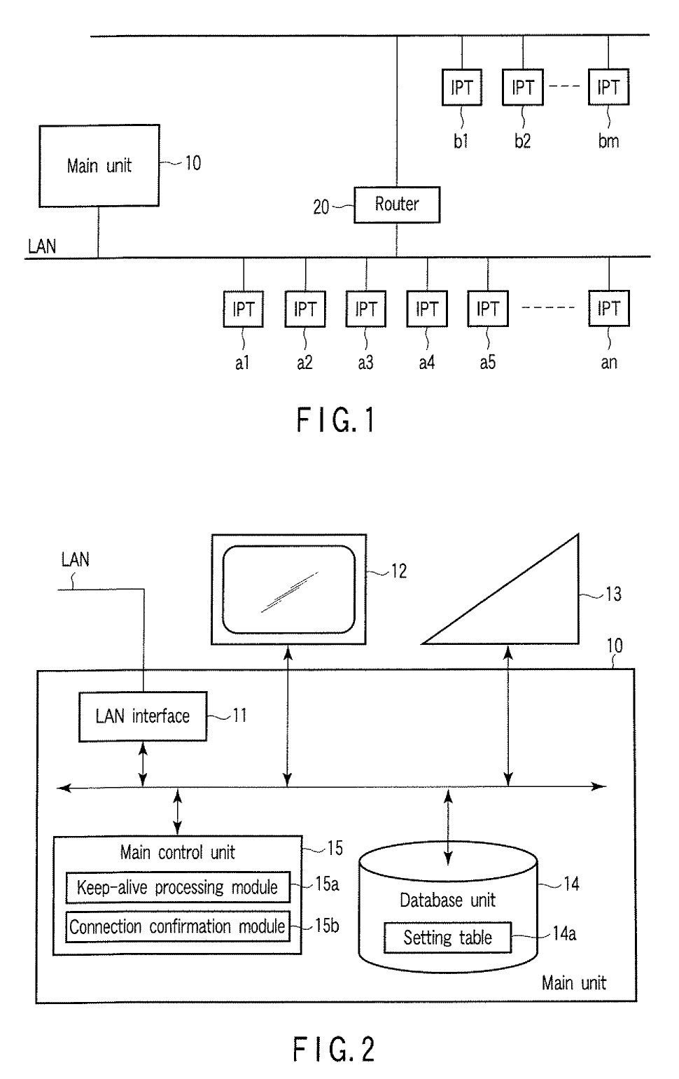

According to an embodiment, FIG. 1 shows a system view illustrating an embodiment of a telephone system. The system is composed mainly of a main unit 10 and a plurality of IP terminals (IPTs) a1-an. The main unit 10 accommodates the IPTs a1-an as its subordinates via a LAN. The main unit 10 has a function as an exchange and controls outer line communication of the IPTs a1-an and extension communication inter-IPT a1-an via a LAN. The main unit 10 performs call control, and maintenance operation control such as data setting and defect detection for each IPS a1-an. In this embodiment, the IPTs a1-an establish a voice communication through transmission and reception of IP packets via the LAN by transmitting and receiving IP packets via the LAN. That is, the LAN is a packet communication network for transmitting IP packets.

Further, IPTs b1-bm are also connected to the LAN through a router 20. The main unit 10 integrally controls the IPTs a1-an, b1-bm. In the embodiment, a segment formed by the IPTs a1-an and segment formed by the IPTs b1-bm are individually treated. That is, the IPTs a1-an and the IPTs b1-bm each belong to different groups. The following will firstly describe processing regarding the IPTs a1-am. For description, it is assumed that n is equivalent to 5, and five IP terminals a1-a5 are connected to the main unit 10 via the LAN.

In the embodiment, a first terminal and order among the IPTs a1-a5 are defined in advance for the IPTs a1-a5. In the embodiment, the IP terminal a1 is set as the first terminal, the order among IPTs is set in order of numbers. That is, the processing in the embodiment is carried out from the IP terminal a1 in accordance with order of a2, a3, a4 and a5. After making a round of these terminals a1-a5, the processing returns from the IPT a5 to the IPT a1 again. The order is stored in advance in a database form and stored in the main unit 10.

FIG. 2 is a functional block diagram illustrating an embodiment of the main unit 10 of FIG. 1. The main unit 10 includes an interface unit 11, display unit 12, an input and output unit 13, a database unit 14 and a main control unit 15. The interface unit 11 is connected to the LAN and takes on processing in relation to transmission and reception of packets. The display unit 12 provides a user interface together with the input and output unit 13 and realizes a graphical user interface (GUI) environment.

The main control unit 15 includes a keep-alive processing module 15a and a connection confirmation module 15b as its processing function. The keep-alive processing module 15a implements keep-alive processing. The keep-alive processing is processing for carrying out to keep effectiveness of IP addresses of devices to be connected to the IP network. In addition to, in the embodiment, the main unit 10 confirms the presence or absence of a connection of each IP terminal to the LAN (terminal presence confirmation) by using various keep-alive messages defined in IP.

In terminal presence confirmation processing, the keep-alive processing module 15a transmits a start message (terminal keep-alive start request) to a first device, namely the IPT a1 via the LAN. When receiving an end message (terminal keep-alive end response) to the transmitted terminal keep-alive start request from the IPT a1 via the LAN, the connection confirmation module 15b confirms that connections of all the IPTs a1-a5 belonging to the same segment as that of the IPT a1 to the LAN are normal.

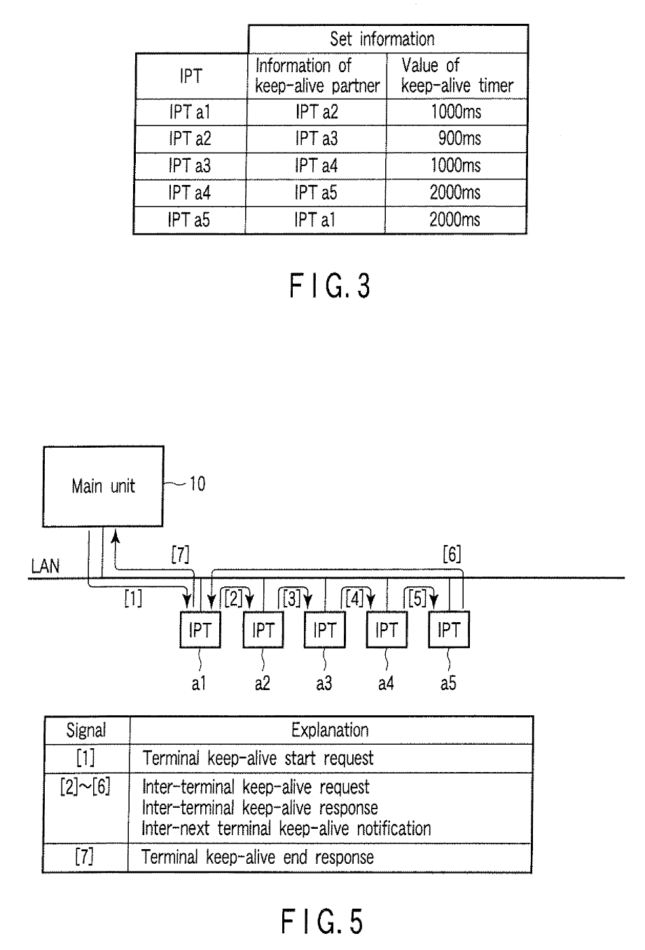

FIG. 3 is a schematic view illustrating an example of the setting table 14a to be stored in the database unit 14. A partner for transmitting the keep-alive message and setting value of a keep-alive timer are recorded in the setting table 14a for each IPT a1-a5. The partner of each IPT a1-a5 is set so that the keep-alive signal goes around from the IPT a1 to the IPT a5, namely so that the keep-alive signal makes a around each IPT.

In FIG. 3, for example, for the IPT a1, the IPT a2 is specified as a partner of the keep-alive. This specification means that the IPT a1 performs the keep-alive processing to the IP terminal a2. The timer setting value is equivalent to 1000 ms (millisecond). That is, when a state of no-response has been continued during 1000 ms after the PT a1 transmits the keep-alive request to the IPT a2, the timer of the IPT a1 times out. When the timer times out, the IPT a1 assumes that the IPT a2 is not connected to the LAN, and notifies the fact to the main unit 10. The same is true on other IPTs a2-a5.

The main unit 10 selects the IPT for performing the keep-alive processing on the basis of the content of the setting table 14a. The main unit 10 notifies the partner information of the inter-terminal keep-alive processing and keep-alive timeout time to the IPTs a1-a5.

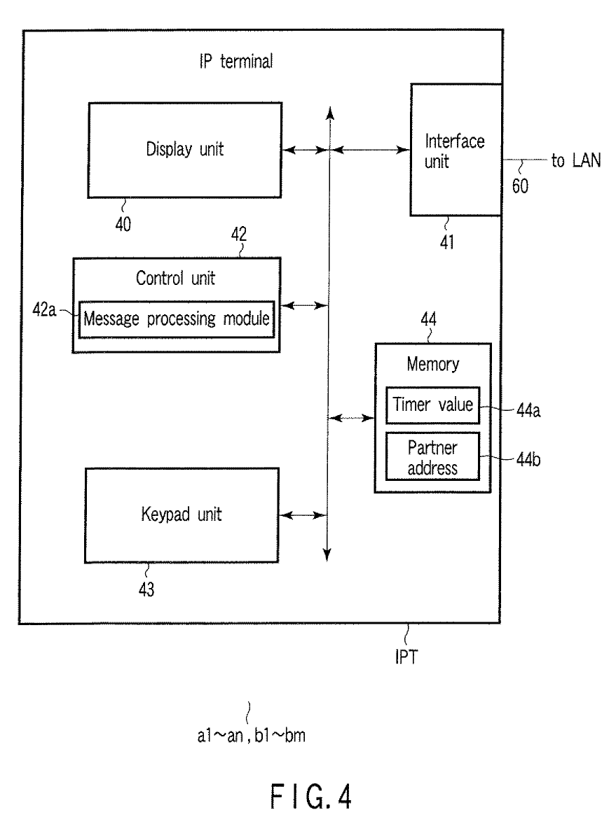

FIG. 4 is a function block diagram illustrating an embodiment of each of the IPTs a1-an, b1-bm of FIG. 1. The IPT a1-an, b1-bm includes an interface unit 41 to be connected to the LAN through a LAN cable 60, a display unit 40, a control unit 42, a keypad unit 43 and a memory 44. Among of them, the display unit 40 is a liquid crystal display (LCD) and visually displays various messages. The keypad unit 43 includes a soft-keys and numeric figure keys, and receives an input operation from a user.

The control unit 42 includes a message processing module 42a. The message processing module 42a transmits and receives various messages including the keep-alive message to and from other IPTs through the LAN. Specifically, the message processing module 42a carried out processing for transmitting and receiving the keep-alive message to and from the partner terminal shown in FIG. 3.

The memory 44 stores a timer value 44a of the keep-alive timer and a partner address 44b shown in FIG. 3. The partner address 44b is a partner's extension number, an IP address, etc. These pieces of information are acquired from the main unit 10 in accordance with a specific trigger. The trigger means a time when its own terminal is connected to the LAN, when data setting work accompanied by increase and/or reduction in the IPTs is performed, or when the software-implemented telephone terminal is started.

FIG. 5 is a schematic diagram illustrating a message flow in the method for confirming the presence of the terminal devices regarding the embodiment. In FIG. 5, arrows indicate flows of processing step-by-step, the processing proceeds in order of a numeric figure in a bracket [] along with each arrow. In the following description, a signal transmitted and received at each processing is referred to as a terminal keep-alive start request, an inter-terminal keep-alive request, an inter-terminal keep-alive response, an inter-next terminal keep-alive notification and a terminal keep-alive end response. The following will describe the detail of each signal and the processing procedure.

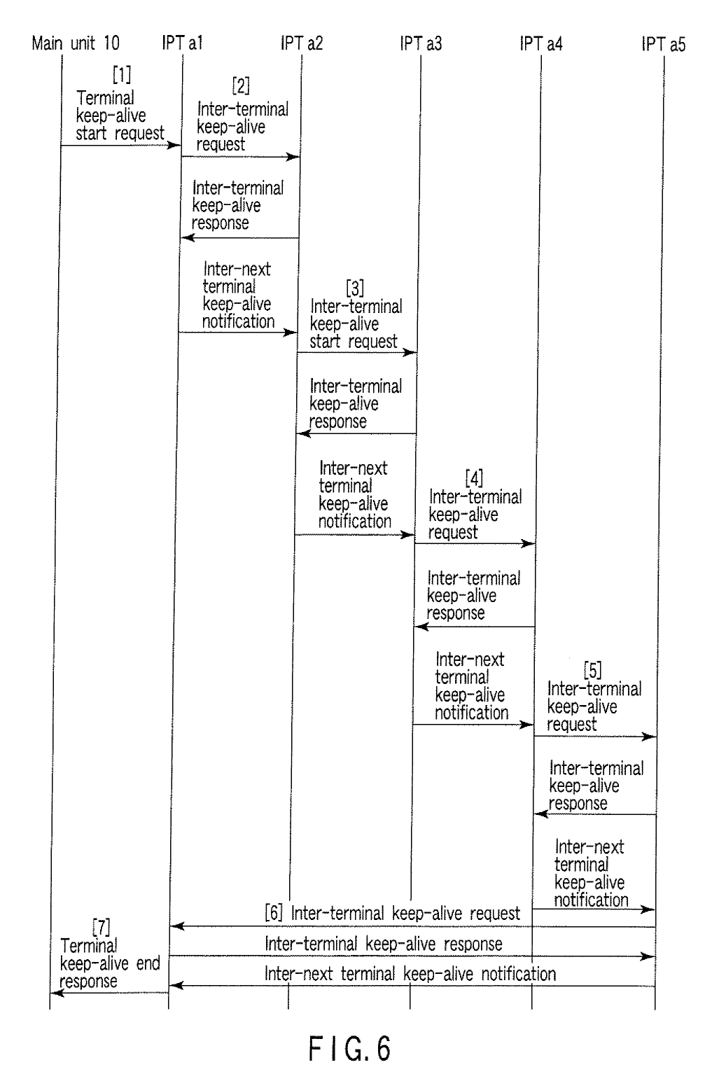

FIG. 6 is a sequence view illustrating a processing procedure in the method for confirming the presence of the terminal device of the embodiment. Firstly, the main unit 10 transmits a ‘terminal keep-alive start request’ to the IPT a1 [1]. The IPT a1 which receives the sent message transmits ‘inter-terminal keep-alive request’ to the IPT a2 that is the next terminal in accordance with the table of FIG. 3 [2]. The IPT a2 which has received the message replies ‘inter-terminal keep-alive response’ to the IPT a1 that is a transmission origin. When receiving the response message, the IPT a1 transmits ‘inter-next-terminal keep-alive notification’ to the IPT a2.

If the procedure has been normally completed so far, it becomes clear that the IPT a2 is connected to the LAN. The IPT a2 transmits ‘inter-terminal keep-alive request’ to the next IPT a3 [3]. After this, procedures of [4]-[6] are carried out in a similar way. Then, the keep-alive message is transferred in order of IPT a1, IPT a2, IPT a3, IPT a4, IPT a5 and IPT a1, and the keep-alive message goes around though all the IPTs a1-a5. At last, when the IPT a1 receives the ‘inter-next terminal keep-alive notification’, the IP terminal al transmits the ‘terminal keep-alive end notification’ from the IPT a5, the IPT a1 transmits the ‘terminal keep-alive end response’ to the main unit 10 as a response to [1]. According to the procedures given above, a series of the keep-alive processing ends.

As mentioned above, if the main unit 10 receives the ‘terminal keep-alive end response’ to the ‘terminal keep-alive start request’ transmitted to the IPT a1 from the IPT a1, the main unit 10 can confirm that all the IPTs a1-a5 are normally connected to the LAN. Because any one of the IPTs a1-a5 has not been connected to the LAN, the main unit 10 cannot receive the ‘terminal keep-alive end response’. The following will describe a procedure for detecting a state in which any of the IPTs becomes absent in the network by reason of the disconnection of the LAN cable 60.

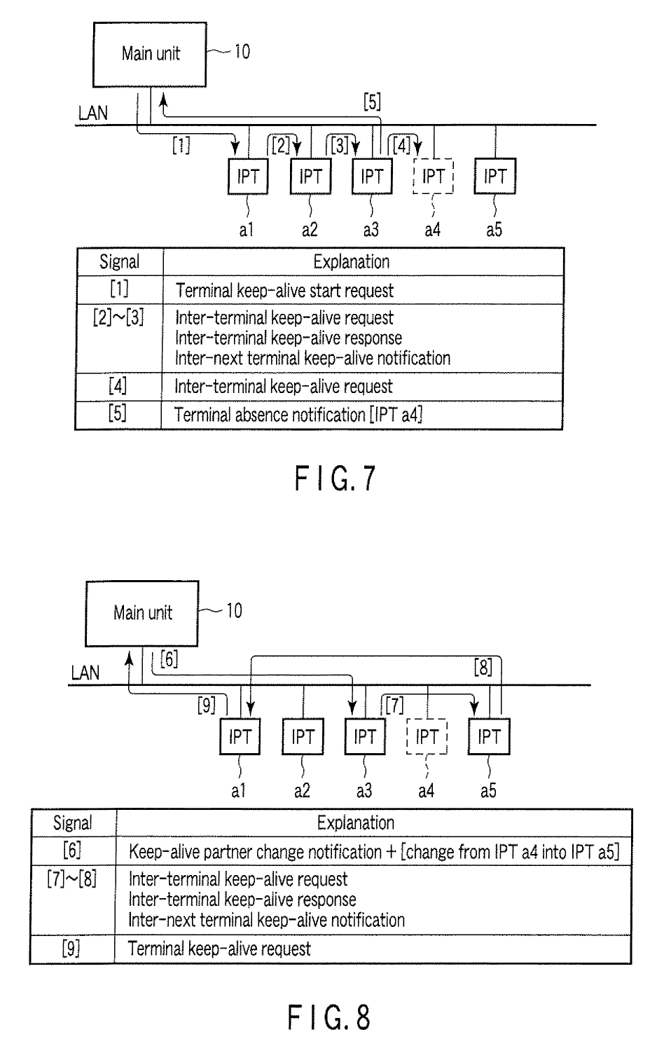

FIG. 7 shows a schematic view illustrating a message flow in a case of absence of any terminal in the embodiment of the method for confirming the presence of the terminal device. Here a case in which the IPT a4 is disconnected from the LAN is assumed. In FIG. 7, at first, the main unit 10 transmits the ‘terminal keep-alive start request’ [1] to the IPT a1. After this, the keep-alive signal is transmitted in order of IPT a1→IPT a2→IPT a3. In the process, the IPT a3 transmits the ‘inter-terminal keep-alive request’ to the IPT a4. However, since the IPT a4 has been disconnected from the LAN, the ‘inter-terminal keep-alive response’ does not return from the IPT a4 to the IPT a3.

A timer value of the IPT a3 is 900 ms (FIG. 3). If the timer value (period) has elapsed without being able to receive the ‘inter-terminal keep-alive response’, the timer Limes out. Then, the IPT a3 transmits a ‘terminal absence notification [IPT a4 absence]’ message [5], indicating the non-presence of the IPT a4, namely the non-connection to the LAN, to the main unit 10. When receiving the ‘terminal absence notification message’, the main unit 10 confirms the non-presence of the IPT a4, and brings the network resources corresponding to the position of the IPT a4 into a closed state. That is, the main unit 10 confirms the absence of the terminal (IPT a4) next to the terminal (IPT a3) which has transmitted the message of the ‘terminal absence notification [absence of IPT a4]’.

If this situation is left as it is, the keep-alive processing stops on its halfway. Then, when detecting the absence of the IPT, the main unit 10 changes the partner of the keep-alive which has already timed out. Here, as shown in FIG. 8, the main unit 10 transmits a ‘keep-alive partner change notification’ message [6] to the IPT a3. Then, the main unit 10 instructs to the IPT a3 so as to charge the partner of the keep-alive from the IPT a4 to the IPT a5.

The IPT a3 which has received the message [6] updates the partner address 44b stored in the memory 44, and transmits an ‘inter-terminal keep-alive request’ message [7] to the IPT a5. In this way, the keep-alive processing of the IPT a4 is skipped. After this, the keep-alive message makes a round in order of IPT a5→IPT a1→main unit 10. In this procedure, the content of the setting table 14a of the main unit 10 is also updated.

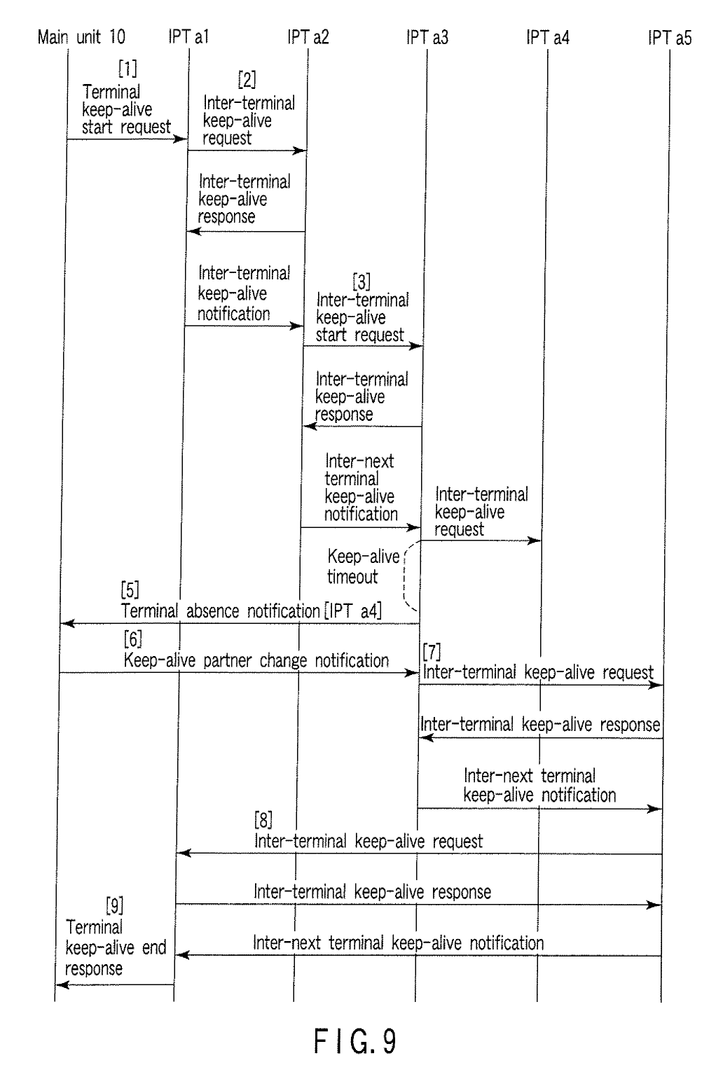

FIG. 9 shows a sequence view illustrating a processing procedure in a case of absence of the terminal. In FIG. 9, it is assumed that after the ‘inter-terminal keep-alive request’ message [4] is transmitted from the IPT a3 to the IPT a4, the timer of the IPT a3 times out. Then, the IPT a3 transmits the ‘terminal absence notification’ message [5] to the main unit 10. In response to this transmission, the main unit 10 transmits the ‘keep-alive partner change notification’ message [6] to the IPT a3. After this, the IPT a4 is skipped, and the keep-alive message makes a round in a similar manner to that is shown FIG. 6.

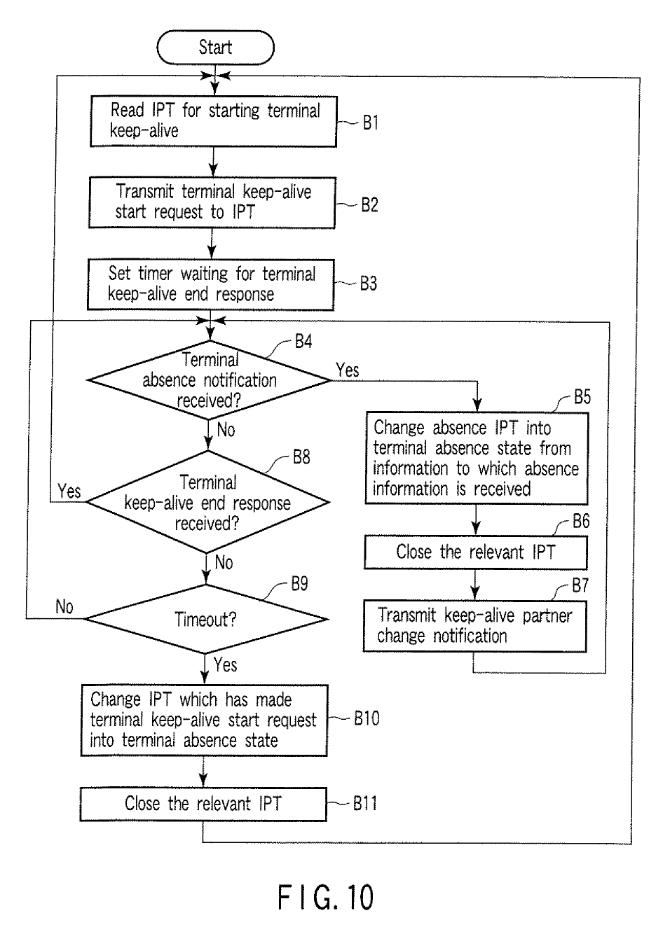

FIG. 10 shows a flowchart depicting a processing procedure of the main unit 10. The main unit 10 reads an IPT that becomes a start origin of terminal keep-alive processing, namely reads the first IPT from the setting table 14a (Block B1), and transmits the ‘keep-alive start request’ message to the read IPT a1 (Block B2). The main unit 10 then sets a timer of waiting for terminal keep-alive end response to its own device so as to detect timeout of keep-alive processing itself (Block B3).

If the main unit 10 receives the terminal keep-alive end response (YES in Block B8), without receiving the notification of terminal absence (NO in Block B4), the main unit 10 may confirm the presence of all the terminals and return to the first Block B1. When receiving notification of the terminal absence (YES in Block B4), the main unit 10 changes the state of the absent IPT notified through the notification into an absence state in an inner database (Block B5), and closes the IPT (Block B6). The main unit 10 transmits the keep-alive partner change notification to the IPT of the massage transmission origin (Block B7).

Meanwhile, in a state in which the main unit 10 does not receive the ‘terminal keep-alive end response’ message (NO in Block B8), if the timer set in Block B3 times out (YES in Block B9), in a word, the first terminal IPT a1 results in absence. Thus, the main unit 10 changes the first IPT into a terminal absence state (Block B10), and closes the IPT (Block B11). In this way, there is a case in which the main unit 10 detects the timeout not depending on the timeout among terminals.

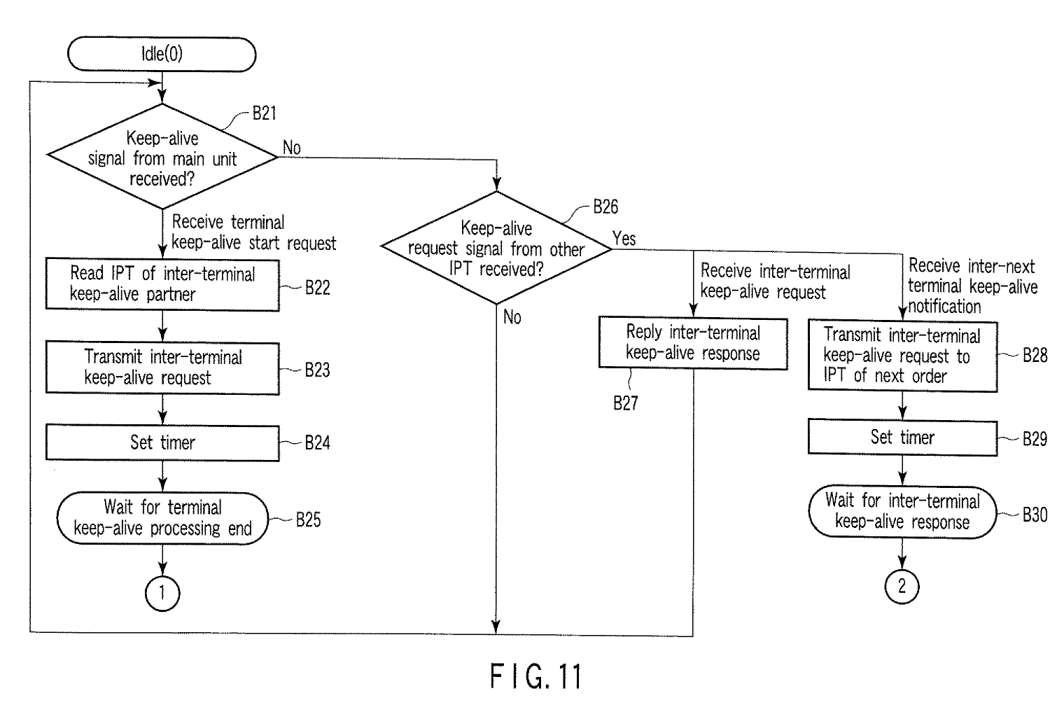

FIGS. 11-14 each show flowcharts depicting processing procedures at the IPTs in keep-alive processing. The processing in Block B21 of FIG. 11 varies in accordance with whether the IPT receives a terminal keep-alive start request from the main unit 10, or whether the IPT receives the keep-alive request signal from other IPTs (NO in Block B21).

In Block B21, if the IPT has received the terminal keep-alive start request, the IPT reads the address of the partner's IPT from the memory 44 (Block B22), and transmits the inter-terminal keep-alive request to the partner (Block B23). The IPT of the transmission origin reads the timer value from the memory 44 (Block B24), and waits for the end of the terminal keep-alive processing (Block B25).

Meanwhile, in Block B21, if the IPT has received the keep-alive request signal from other IPT, the procedure shifts to Block B26. In Block B26, the IPT determines whether or not the received keep-alive request signal is the inter-terminal keep-alive request. If the request signal is the inter-terminal keep-alive, the IPT which has received this request signal replies the inter-terminal keep-alive response to the IPT of the preceding order (Block B27). If the request signal is the inter-next terminal keep-alive notification, the IPT which has received this notification transmits the inter-terminal keep-alive request to the IPT of the next order (Block B28), then, sets the timer (Block B29) and waits for the inter-terminal keep-alive response.

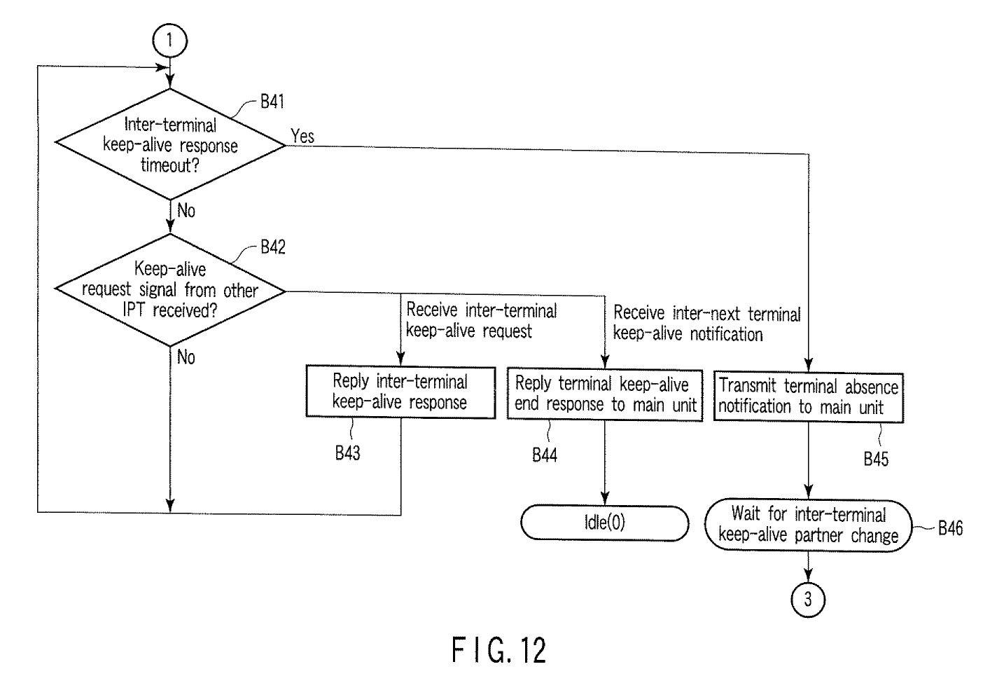

FIG. 12 shows a procedure after Block B25 in FIG. 11. In Block B41 of FIG. 12, it is assumed that timeout occurs without receiving any inter-terminal keep-alive response (YES in Block B41). Then, the IPT which has detected the timeout transmits the terminal absence notification to the main unit 10 (Block B45), and waits for an instruction of change in inter-terminal keep-alive partner from the main unit 10 (Block B46).

In the meantime, it is assumed that the IPT does not time out (NO in Block B41), and the IPT receives the keep-alive request signal from other IP terminal (YES in Block B42). If the request signal is the ‘inter-terminal keep-alive request’ message, the IP terminal which has received the request signal replies the inter-terminal keep-alive response to the IPT of the preceding order (Block B43). If the request signal is the inter-next terminal keep-alive notification, the IPT which has received this notification replies the terminal keep-alive end response to the main unit (Block B44).

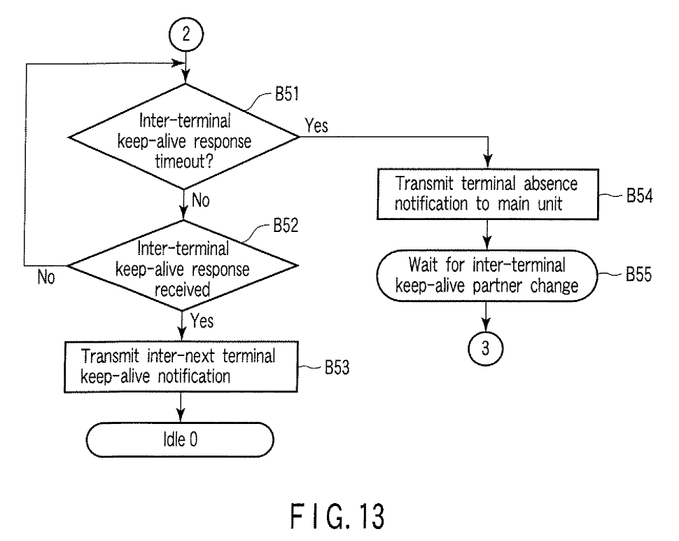

FIG. 13 shows a procedure in Block B30 of FIG. 11 or later. In Block B51 of FIG. 13, it is assumed that timeout occurs without receiving any inter-terminal keep-alive response (YES in Block B51). The IPT which has detected the timeout transmits the terminal absence notification to the main unit 10 (Block B54), and waits for the instruction for a change in inter-terminal keep-alive partner (Block B46).

Meanwhile, if the timeout does not occur (NO in Block B51), and if the IPT receives the inter-terminal keep-alive response from the partner's IPT (YES in Block B52), the IPT which has received the response transmits the inter-next terminal keep-alive notification to the partner's IPT (Block B53).

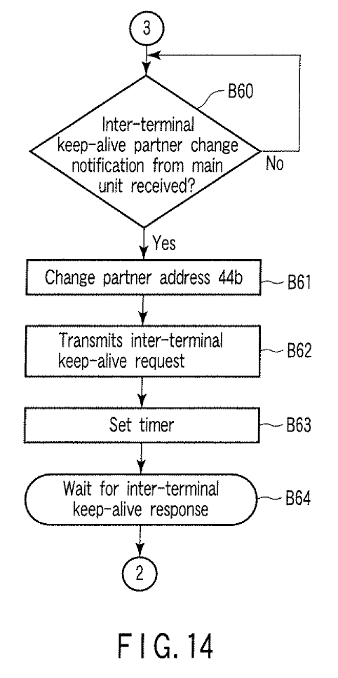

FIG. 14 shows procedures in Block B46 of FIG. 12 and Block B55 of FIG. 13 or later. When the IPT receives the inter-terminal keep-alive partner change notification from the main unit 10 (YES in Block B60), the IPT which has received this notification changes the partner address 44b in the memory 44 (Block B61), and transmits the inter-terminal keep-alive request to the changed partner (Block B62). Then, the IPT sets a timer value (Block B63), and waits for the inter-terminal keep-alive response from a new partner (Block B64).

In general, in the embodiment, when the main unit 10 transmits a start message, a confirmation message and a reply message are transmitted and received between the first IPT and the next IPT mutually. When the transmission and reception is completed successfully, the first IPT transmits a notification message to the next IPT, and the IPT which has received the notification message further transmits a confirmation message to the next IPT. The exchanges of the massage are repeated among terminals in defined order, and the message makes a round of all the IPTs, then, an end message is transmitted to the main unit 10.

When receiving the end message, the main unit 10 may conclude that all the IPTs are normally connected to the LAN. In this procedure, the main unit 10 may transmit and receive the message to and from the first IPT. Therefore, regardless of the number of IP terminals, it becomes able for the telephone system to dramatically reduce the processing burden on the main unit 10.

As mentioned above, in the embodiment, if order is put to the IPTs a1-a5 in advance, and the keep-alive message makes a round in accordance with the order, the main unit 10 recognizes that all the IPTs a1-a5 are connected to the LAN. That is, if the terminal keep-alive end response for the terminal keep-alive start request transmitted from the main unit 10 comes back to the main unit 10, all the IPTs a1-a5 are present on the LAN. The IPTs mutually perform the keep-alive processing among terminals in turn. in the process, if timeout occurs, the IPT which has detected the occurrence notifies the absence of other IPTs to the main unit 10, and change the order of the keep-alive processing.

In such a procedure, for confirming the presence and absence of the terminals, the message to be transmitted from the main unit 10 is only the terminal alive start request. The messages to be received by the main unit 10 are only the terminal keep-alive start request and the keep-alive partner change notification. That is, even if the number of the IPTs to be connected to the LAN is large, since the keep-alive start signal from the main unit 10 is enough only by one single, the processing burden on the main unit 10 in the keep-alive processing does not vary. Therefore, even if the number of connections of the IPTs is large, the presence and absence of all the IPTs can be detected in a short time without increasing the processing burden on the side of the main unit 10 and traffic on the LAN. Not like the prior art, there is no need to browse failure management information among terminals, and there is no need to transmit the message in an interactive direction.

In the embodiment, as shown in FIG. 3, the timeout time of the keep-alive processing is set for each IPT. This is especially useful in a case where there are a plurality of segments as shown in FIG. 1. That is, the timeout time is set shorter in the keep-alive processing among IPTs belonging to the same segment with the main unit 10, and the timeout time is set longer in the keep-alive processing among IP terminals belonging to the other segments. Setting in this way enables the telephone system to absorb a time difference in a network required to transmit and receive the message, and enables the system flexibly to correspond to various forms of networks. Further, the system enables shortening a total detection time required to detect the presence and absence of the terminals.

While the embodiment has taken the IPTs a1-a5 as examples and has made the keep-alive message make a round in a group, the invention is not limited to the foregoing embodiment, for example, tow groups, such as a group of the IPTs a1-a3 and a group of the IPTs a4-a5, may be formed, and the keep-alive processing may be performed for each group. In such a case, the setting table 14a of FIG. 3 is provided for each group, and the main unit 10 transmits the terminal keep-alive start request for each group. Even in such a case, the burden on the main unit 10 and the network burden may be considerably reduced.

As regards another form of grouping, grouping for each segment in FIG. 1 is also effective. That is, the IPTs a1-an may be set as a first group and the IPTs b1-bm may be set as a second group.

As mentioned above, according to the embodiment, a telephone system configured to perform presence confirmation of a terminal for a short time without increasing a processing load on a main unit and communication traffic, its terminal device and a method for confirming presence of a terminal may be provided.

The invention is not limited to the aforementioned embodiment. For instance, a terminal to be an object of detection of presence and absence is not limited to the IPT, a session initiation protocol (SIP) terminal can be used, and a terminal with other form can be used. In short, as long as a terminal capable of being connected Lo a network and controlled by a main unit, all kinds of terminals can be accepted. Further, the protocol to be used on the network is not limited to the IP.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone system, including a plurality of terminal devices configured to perform telephone communication via a packet communication network; and a main unit configured to accommodate the plurality of terminal devices via the packet communication network, wherein
a first terminal device and order which starts from the first terminal device to come back to the first terminal device while making a round the plurality of terminal devices are specified to the plurality of terminal devices in advance;
the main unit comprises:
a transmission module which transmits a start message to the first terminal device via the packet communication network; and
a confirmation processing module which confirms that the respective connections of the plurality of terminal devices to the packet communication network are normal when an end message to the transmitted start message is received from the first terminal device via the packet communication network,
the terminal device comprises:
a message processing module which mutually transmits and receives messages to and from other terminal devices via the packet communication network,
wherein
the message processing module
transmits a confirmation message to a terminal device next to its own terminal in accordance with the order when the start message is received,
replies a response message to a terminal device of a transmission origin of the confirmation message when the confirmation message is received,
transmits a notification message to a terminal device of a transmission origin of the response message when the response message is received,
transmits the confirmation message to the terminal device next to its own terminal in accordance with the order if its own terminal is not the first terminal device, and transmits the end message to the main unit if its own terminal is the first terminal device when the notification message is received.

2. The telephone system of claim 1, wherein
the message processing module transmits an absence message, showing a non-connection of the terminal device which should transmits the response message to the packet communication network, to the main unit when the response message is not received within a defined time; and
the confirmation processing module confirms absence of a terminal device next to the terminal device which has transmitted the absence message.

3. The telephone system of claim 2, wherein the main unit further comprises:
a specification processing module which specifies the defined time for each of the terminal devices.

4. The telephone system of claim 1, wherein
the plurality of terminal devices are divided into a plurality of groups;
the first terminal device and the order are specified to the groups, respectively;
the transmission module individually transmits the start message to the first terminal device for each of the groups; and
the confirmation processing module confirms that connections of terminal devices belonging to a group to the packet communication network are normal in the group to which the terminal device which has transmitted an end message to the start message transmitted for each of the groups.

5. The telephone system of claim 1, wherein
the packet communication network is an Internet Protocol (IP) network, and
the message is a keep-alive message defined on the IP network.

6. A terminal device for use in a telephone system comprising a plurality of terminal devices configured to perform telephone communication via a packet communication network and a main unit configured to accommodate the plurality of terminal devices via the packet communication network, wherein
the telephone system specifies in advance a first terminal device and order, which starts from the first terminal device to come back to the first terminal device while making a round the plurality of terminal devices, to the plurality of terminal devices;
the terminal device includes a message processing module which mutually transmits and receives messages to and from other terminal devices via the packet communication network; and
the message processing module
transmits a confirmation message to a terminal device next to its own terminal in accordance with the order when the start message for starting presence confirmation processing of any terminal device from the main unit is received,
replies a response message to a terminal device of a transmission origin of the confirmation message when the confirmation message is received,
transmits a notification message to a terminal device of a transmission origin of the response message when the response message is received,
transmits the confirmation message to the terminal device next to its own terminal in accordance with the order if its own terminal is not the first terminal device, and transmits the end message to the main unit if its own terminal is the first terminal device when the notification message is received.

7. The terminal device of claim 6, wherein
the message processing module transmits an absence message, showing a non-connection of the terminal device which should transmits the response message to the packet communication network, to the main unit when the response message is not received within a defined time.

8. The terminal device of claim 6, wherein
the packet communication network is an Internet protocol (IP) network, and
the message is a keep-alive message defined on the IP network.

9. A method for confirming presence of the terminal devices for use in a telephone system, including a plurality of terminal devices configured to perform telephone communication via a packet communication network; and a main unit configured to accommodate the plurality of terminal devices via the packet communication network, comprising:
specifying in advance a first terminal device and order, which starts from the first terminal device to come back to the first terminal device while making a round the plurality of terminal devices, to the plurality of terminal devices;
transmitting a start message for starting presence confirmation processing of any terminal device to the first terminal device from the main unit via the packet communication network;
transmitting a confirmation message to the next terminal in accordance with the order from the terminal device which has received the start message;
replying a response message to the terminal device of the transmission origin of the confirmation message from the terminal device which has received the confirmation message;
transmitting a notification message to a terminal device of a transmission origin of the response message from the terminal device which has received the response message; and
transmitting a confirmation message to the next terminal in accordance with the order from a terminal device that is not the first terminal device when the terminal device receives the notification message;
transmitting an end message showing the end of the presence confirmation processing from the terminal device to the main unit when the first terminal device receives the notification message, wherein
the main unit confirms that the respective connections of the plurality of terminal devices to the packet communication network are normal when the main unit receives the transmitted end message to the start message from the first terminal device via the packet communication network.

10. The method confirming the presence of the terminal device of claim 9, wherein:
when the response message is not received within a defined time, the terminal device transmits an absence message, showing a non-connection of the terminal device which should transmit the response message to the packet communication network, to the main unit; and
the main unit confirms absence of a terminal device next to the terminal device which has transmitted the absence message.

11. The method confirming the presence of the terminal of claim 10, wherein
the main unit specifies the defined time for each terminal device.

12. The method confirming the presence of the terminal of claim 9, further comprising:
dividing the plurality of terminal devices into a plurality of groups;
specifying the first terminal device and the order to the groups, respectively;
individually transmitting the start message to a first terminal device for each of the groups; and
confirming that connections of terminal devices belonging to a group to the packet communication network are normal in the group to which the terminal device, which has transmitted an end message to the start message for each of the groups, belongs.

13. The method for confirming the presence of the terminal of claim 9, wherein
the packet communication network is an Internet protocol (IP) network, and the message is a keep-alive message to be defined on the IP network.
